(19) United States
(12) Patent Application Publication
(10) Pub. No.: US 2003/0133506 A1
(43) Pub. Date: Jul. 17, 2003

(54) IMAGE PROCESSOR CONTROLLING B-PICTURE MEMORY

(76) Inventor: TARO HANEDA, TOKYO (JP)

Correspondence Address: SCULLY SCOTT MURPHY & PRESSER, PC, 400 GARDEN CITY PLAZA, GARDEN CITY, NY, 11530

(21) Appl. No.: 09/286,974

(22) Filed: Apr. 6, 1999

(30) Foreign Application Priority Data
Apr. 6, 1998 (JP) 093248/1998

(51) Int. Cl. H04N 7/12

(52) U.S. Cl. 375/240.25; 382/233; 375/240.15

(57) ABSTRACT

An image processor that can reduce in capacity of a B-picture memory is disclosed. The B-picture memory stores luminance data and color-difference data of decoded image data included in a top field and a bottom field of a B picture. The B-picture memory is controlled by a memory controller which independently controls a memory area storing the luminance data and another memory area storing the color-difference data in the memory. Preferably, the memory controller releases the memory area storing the luminance data included in one of the top and bottom fields that has been displayed.

### BACKGROUND OF THE INVENTION

1. Field of the Invention

The present invention generally relates to image processors, and in particular to a memory control method and system in an image processor which can output decoded moving pictures while decoding compression-encoded data including B-picture data conforming to MPEG (Moving Picture Experts Group) standards.

2. Description of the Related Art

There has been proposed an image decoding system which can outputs decoded images in real time while decoding a stream including MPEG encoded video and audio data. Moving-picture encoded data in the stream includes consecutive picture groups each including one I-picture (Intra Picture: intra-frame encoded picture) followed by a plurality of pictures each being one of P-picture (Predictive Picture; inter-frame predictive encoded picture) and B-picture (Bidirectional Picture: bidirectional predictive encoded picture). The I-picture can be decoded without referring to other pictures and the following pictures can be decoded with reference to other pictures.

In MPEG-2 aiming at general-purpose encoding which does not limit an application field, a B-Picture is composed of two or more slice layers, and each slice layer is formed from arbitrary numbers of macroblocks. Each macroblock is composed of a luminance signal Y consisting, for example, of 16×16 pixels, and color-difference signals Cb and Cr each consisting, for example, of 8×8 pixels

In a conventional image processor, the picture of a macroblock which consists of luminance signal Y and the color-difference signals Cb and Cr is decoded per slice. A macro block line is divided into 2 sorts of fields, the even-number field (top field) and odd-number field (bottom field).

For example, there have been two methods for converting B-picture which has been decoded according to the 4:2:0 format and stored in a memory into 4.2:2 format to display it. One method is to generate a color-difference signal lacking in displaying from the color-difference signal of the same field. The other method is to generate the color-difference signal also using the color-difference signal of another field in the same frame. The latter method is called a progressive-C method.

According to a conventional image processor which decodes B-picture using the Progressive-C method, as shown in FIG. 1A, an available index control memory 11, a B-picture memory 12, and a display index control memory 13 are used to manage the picture processing.

The B-picture memory 12 is divided into m slices to which index numbers 0 to m−1 (here, m=6) are assigned, respectively. Each slice is a memory area including data corresponding to a luminance signal Y for 16 lines and a color-difference signal for 8 lines. The index numbers are used to manage the presence and absence of data.

The available index control memory 11 stores an index number indicating an available memory area to which data can be written. The available index memory 11 uses a write pointer WP and a read pointer RP for address management.

The display index control memory 13 stores a display index number indicating which memory area of the B-picture memory 12 the image data to be displayed is located in. The display index control memory 13 has the capacity of at least two frames to store the display index corresponding to a frame picture while decoding another frame picture.

In the case of decoding a frame picture, each time 32 lines for two slices have been decoded, two index numbers are read from the available index control memory 11. At the same time, the read pointer RP of the available index control memory 11 is incremented by two. Thereafter, the read index numbers are stored as display index numbers onto the display index control memory 13.

In the case of decoding a field picture, each time top or bottom 16 lines for two slices have been decoded, one index number is read from the available index control memory 11. At the same time, the read pointer RP of the available index control memory 11 is incremented by one. Thereafter, the read index number is stored onto the display index control memory 13.

In the case of displaying, the display index number indicating which memory area of the B-picture memory 12 the slice data to be displayed is located in is read from the display index control memory 13. The read display index number is used to calculate the location of the memory area storing the slice data to be displayed and the slice data to be displayed is read out from the B-picture memory 12. At the time when two-slice data has been read, the index number corresponding to data which is no longer necessitated is stored as an available index number onto the available index control memory 11 and then the write pointer WP is incremented by one.

In the case of displaying B-picture data in the Progressive-C method, the field data that has been displayed needs only the color-difference signal. However, according to the conventional image processor as described above, it is necessary to hold the luminance signal that is no longer necessitated after displayed.

As shown in FIG. 1B, at the time when starting the bottom of the B0 frame displaying, the luminance data in the top of the B0 frame remains stored in the B-picture memory 12. Therefore, a memory capacity more than necessary is needed.

### SUMMARY OF THE INVENTION

An object of the present invention is to provide an image processor and a memory control therefor, which can achieve a reduction in capacity of a B-picture memory in a system that a color-difference signal is generated with reference to another color-difference signal in B-picture.

The inventor has found that the memory areas corresponding to luminance signals can be released by independently controlling luminance data and color-difference data in each slice of B-picture data.

According to the present invention, an image processor includes a decoder for decoding moving-picture compression-encoded data including B picture data conforming to MPEG (Moving Picture Experts Group) standards; a memory for storing luminance data and color-difference data of decoded image data included in a top field and a bottom field of a B picture; a display for displaying pictures based on decoded image data; and a memory controller for independently controlling a memory area storing the luminance data and another memory area storing the color-difference data in the memory.

The memory controller may release the memory area storing the luminance data included in one of the top and bottom fields that has been displayed. When a total of released memory areas has reached at least a predetermined amount, the memory controller may write decoded image data onto the released memory areas.

As described above, according to the present invention, luminance data and color-difference data are independently managed in each slice of B-picture data. Therefore, in the case where the color-difference data of the B picture is displayed with reference to other color-difference data of another field in the same frame, the memory areas corresponding to luminance signals can be released, resulting in a reduction in capacity of a B-picture memory.

### BRIEF DESCRIPTION OF THE DRAWINGS

FIG. 1A is a diagram showing an example of a conventional B-picture memory control method;

FIG. 1B is a time chart showing an example of the processes of decoding and displaying in the conventional B-picture memory control method;

FIG. 2 is a block diagram showing a memory control system according to the present invention;

FIG. 3A is a schematic diagram showing an available index control memory for explanation of an operation of the memory control system;

FIG. 3B is a schematic diagram showing a display index control memory for explanation of the operation of the memory control system;

FIG. 3C is a schematic diagram showing a B-picture memory for explanation of the operation of the memory control system;

FIG. 4 is a schematic diagram showing a first step in a memory control operation according to a first embodiment of the present invention;

FIG. 5 is a schematic diagram showing a second step of the operation of the first embodiment;

FIG. 6 is a schematic diagram showing a third step of the operation of the first embodiment;

FIG. 7 is a schematic diagram showing a fourth step of the operation of the first embodiment;

FIG. 8 is a schematic diagram showing a fifth step of the operation of the first embodiment;

FIG. 9 is a schematic diagram showing a sixth step of the operation of the first embodiment;

FIG. 10 is a schematic diagram showing a first step of a memory control operation according to a second embodiment of the present invention;

FIG. 11 is a schematic diagram showing a second step of the operation of the second embodiment; and

FIG. 12 is a schematic diagram showing a third step of the operation of the second embodiment.

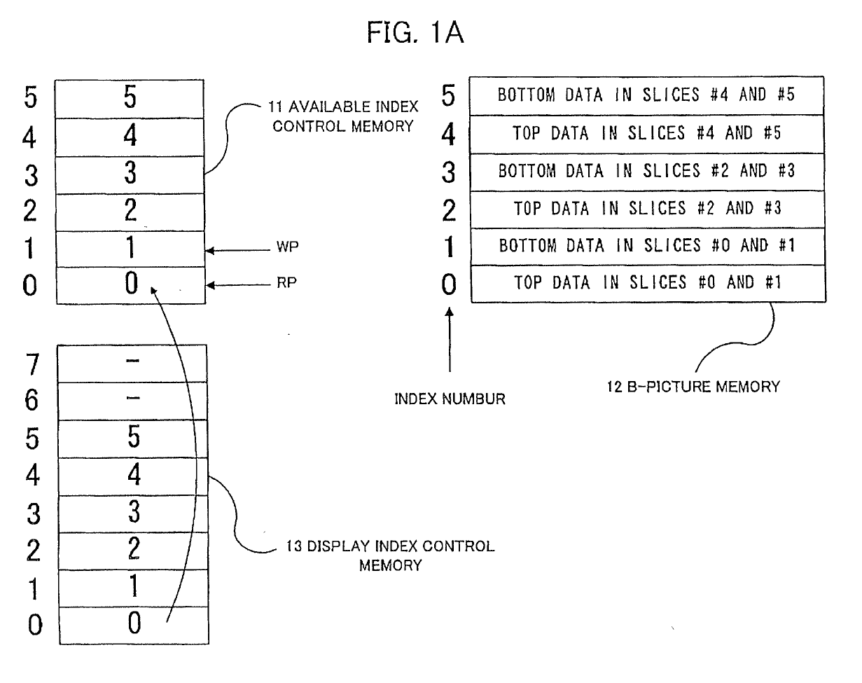

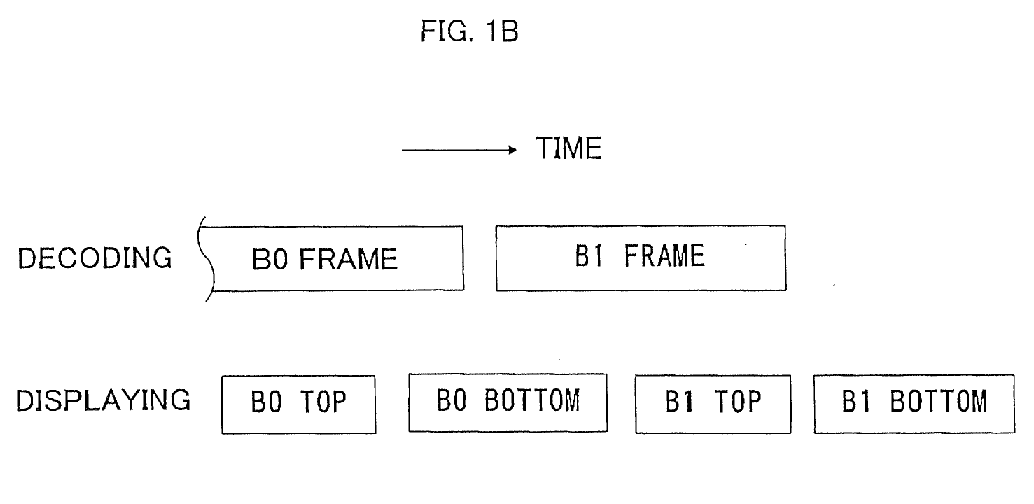

### DETAILED DESCRIPTION OF THE PREFERRED EMBODIMENTS

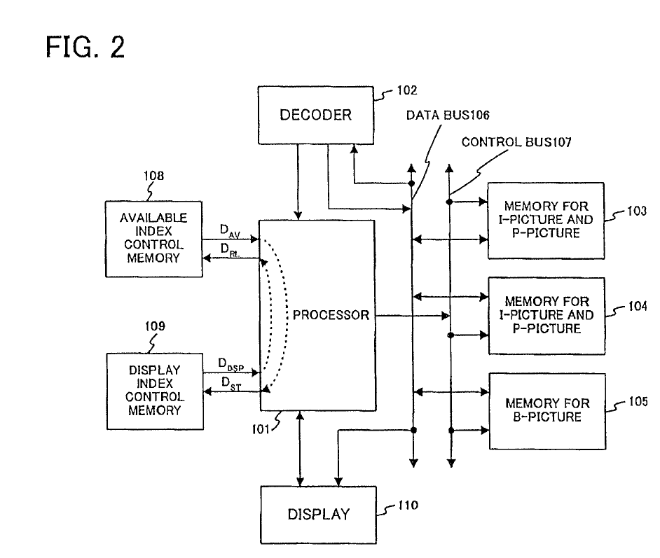

Referring to FIG. 2, an image processing system is composed of a processor 101 and a decoder 102 which are connected to a first memory 103 for I-picture and P-picture, a second memory 104 for I-picture and P-picture, and a third memory 105 for B-picture through a data bus 106 and a control bus 107. The processor 101 uses an available index control memory 108 and a display index control memory 109 to control the B-picture memory 105. Further, the processor 101 is connected to a display 110, which is further connected to the memories 103-105 through the data bus 106.

The image processing system has a function of displaying decoded image data on the display 110 in real time while the decoder 102 decoding a stream of MPEG compression-encoded data of picture groups including an I picture followed by a plurality of B pictures using the memories 105, 108, and 109. More specifically, the available index control memory 108 outputs available index data D_{AV} to the processor 101 and receives release index data D_{RL} from the processor 101. The display index control memory 109 outputs display index data D_{DSP} to the processor 101 and receives stored index data D_{ST} from the processor 101. The display 110 receives decoded picture data from the data bus 106 to display the picture under the control of the processor 101.

The B-picture memory 105 is divided into m slices to which index numbers 0 to m−1 are assigned, respectively. In the case of frame picture decoding, each slice stores the following data:

1. four lines of lower-half data (Y0, Y1) of a luminance signal Y in top field;

2. four lines of upper-half data (Y2, Y3) of the luminance signal Y in top field;

3. four lines of color-difference signal C in top field;

4. four lines of lower-half data (Y0, Y1) of a luminance signal Y in bottom field;

5. four lines of lower-half data (Y0, Y1) of a luminance signal Y in bottom field; and

6. four lines of color-difference signal C in bottom field.

In the case of field picture decoding, each slice of the B-picture memory 105 stores the following data:

1. four lines of lower-half data (Y0, Y1) of a luminance signal Y of lower-half slice in top or bottom field;

2. four lines of upper-half data (Y2, Y3) of the luminance signal Y of lower-half slice in top or bottom field;

3. four lines of color-difference signal C of lower-half slice in top or bottom field;

4. four lines of lower-half data (Y0, Y1) of a luminance signal Y of upper-half slice in top or bottom field;

5. four lines of upper-half data (Y2, Y3) of the luminance signal Y of upper-half slice in top or bottom field; and

6. four lines of color-difference signal C of upper-half slice in top or bottom field.

The available index control memory 108 stores an index number indicating an available memory area to which data can be written. The available index control memory 108 uses a write pointer WP and a read pointer RP for address management.

The display index control memory 109 stores a display index number indicating which memory area of the B-picture memory 105 the image data to be displayed is located in.

In the case of displaying, the display index data D_{DSP} is read from the display index control memory 109. The processor 101 uses the read display index number to calculate the location of the memory area storing the slice data to be displayed and the slice data to be displayed is read out from the B-picture memory 105. At the time when slice data has been read, the index number corresponding to data which is no longer necessitated is stored as an available index number onto the available index control memory 108 and then the write pointer WP is incremented by one.

Hereinafter, the control method according to the first embodiment will be described in the case of decoding frame picture. As an example, the case where a B picture consists of pixels of 128 (16×8) lines is taken.

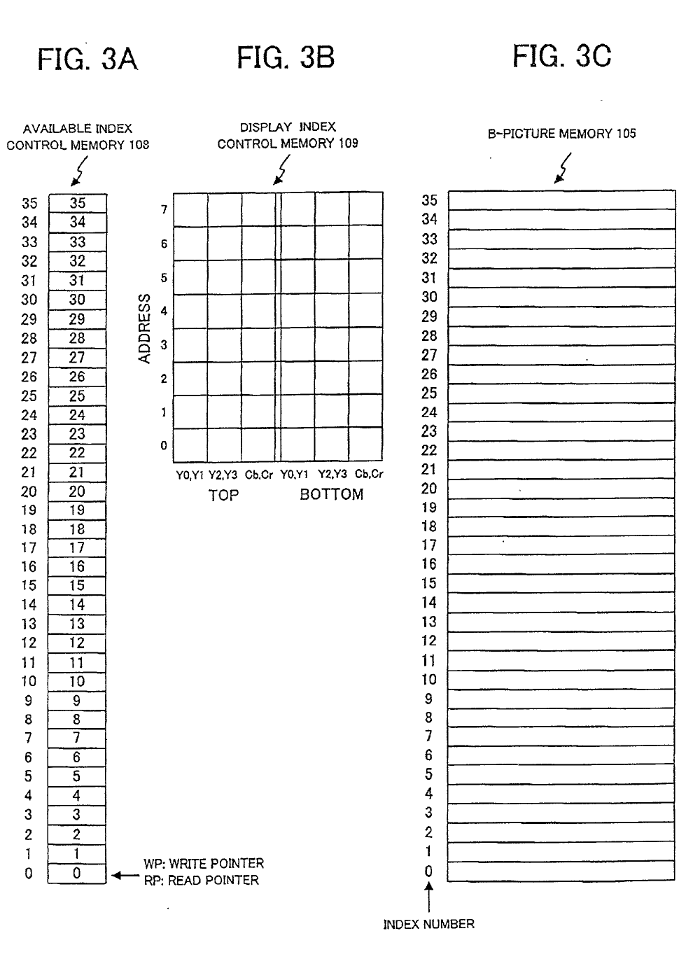

Referring to FIG. 3A, the available index control memory 108 is divided into 36 areas having addresses numbered in sequence from 0 to 35. The write pointer WP and the read pointer RP are incremented depending on the number of available indexes as will be described.

Referring to FIG. 3B, the display index control memory 109 is divided into eight slices numbered in sequence from 0 to 7 and each slice is mainly divided into three top areas and three bottom areas. Each of the top and bottom areas consists of an first area for storing a display index corresponding to lower-half data (Y0, Y1) of a luminance signal Y, a second area for storing a display index corresponding to the upper-half data (Y2, Y3) of the luminance signal Y, and a third area for storing a display index corresponding to color-difference signal Cb, Cr.

Referring to FIG. 3C, the B-picture memory 105 has a capacity for six slices, each of which is divided into 6 areas. In other words, the B-picture memory 105 consists of 36 (6×6) areas numbered in sequence from 0 to 35.

As shown in FIGS. 3A-3C, just after having been reset, the processor 101 initializes the available index control memory 108 such that release index data DRL is transferred to the available index control memory 108 and is written onto each of the memory areas 0-35. At this time, the B-picture memory 105 and the display index control memory 109 both remains in an available state and the write pointer WP and the read pointer RP are set at an address of 0.

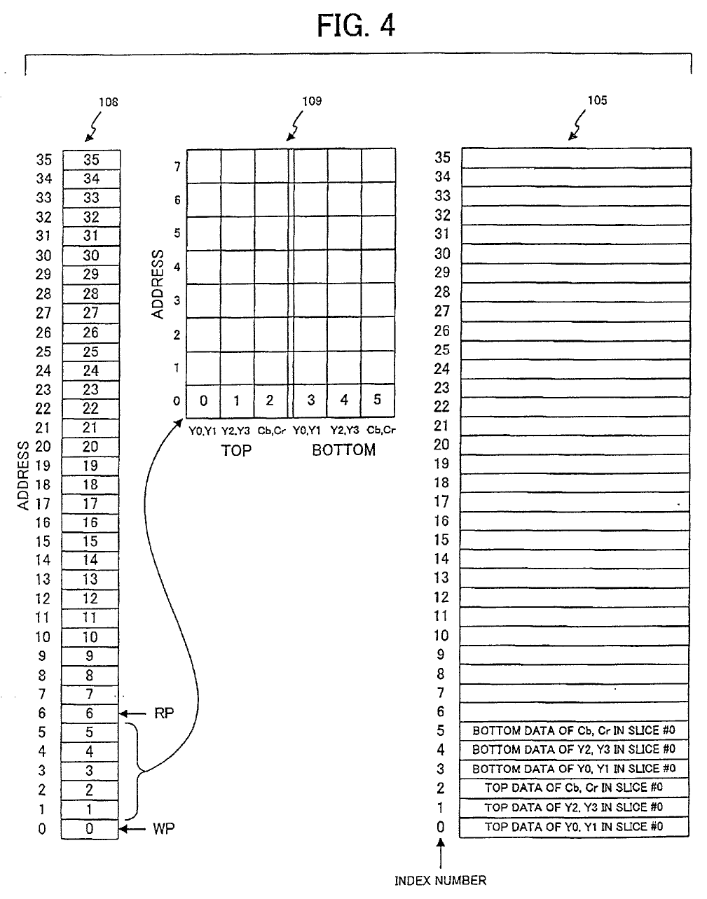

Referring to FIG. 4, the processor 101 reads available index data D_{AV} from the available index control memory 108 and the obtained six indexes (here, 0-5) are written as display indexes onto the slice having the address of 0 in the display index control memory 109. At the same time, the processor 101 outputs a decoding start instruction to the decoder 102 to start the slice #0 of the B-picture memory 105 decoding.

The decoded image data is transferred from the decoder 102 to the B-picture memory 105 through the data bus 106. In the B-picture memory 105, the respective memory areas indicated by the indexes 0-2 store the lower-half data (Y0, Y1) of a luminance signal Y in slice #0 of top, the lower-half data (Y2, Y3) of the luminance signal Y in slice #0 of top, and data of the color-difference signal Cb, Cr in slice #0 of top. Thereafter, the respective memory areas indicated by the indexes 3-5 store the lower-half data (Y0, Y1) of a luminance signal Y in slice #0 of bottom, the lower-half data (Y2, Y3) of the luminance signal Y in slice #0 of bottom, and data of the color-difference signal Cb, Cr in slice #0 of bottom. In the available index control memory 108, the read pointer RP is incremented by six to be moved from the address of 0 to an address of 6.

The decoding steps as described above are repeatedly performed for the slices #0-#4, and thereby the decoded image data of slices #0 to #4 are stored in the memory areas indicated by the index numbers 0 to 29 in the B-picture memory 105. At this time, the read pointer RP of the available index control memory 108 is set at an address of 30.

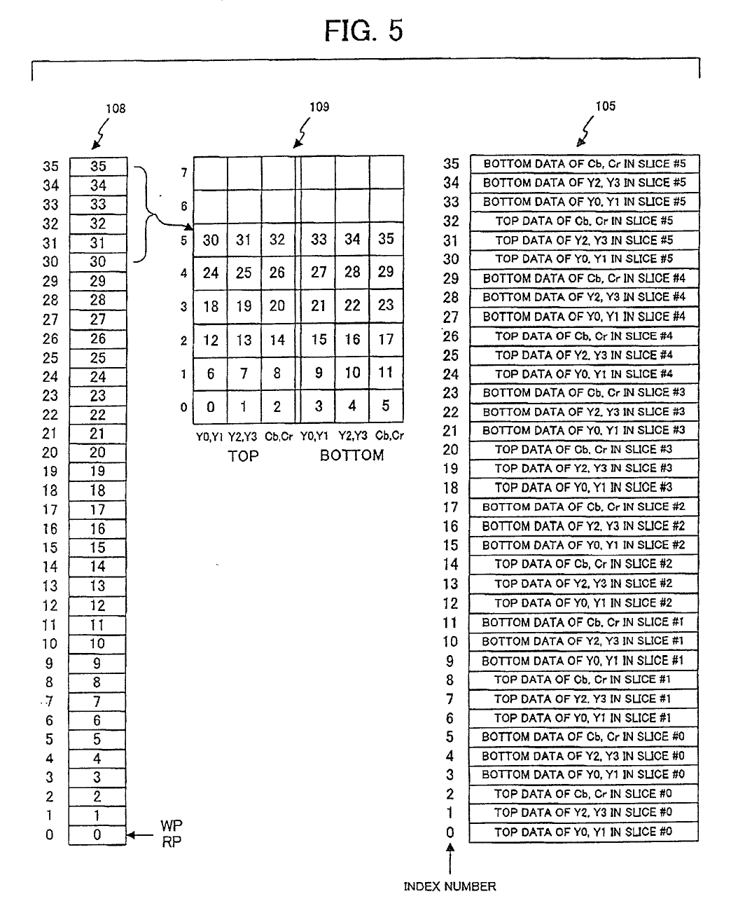

Referring to FIG. 5, when the decoding of the slice #5 is started, the processor 101 reads available index data D_{AV} from the available index control memory 108 and the obtained six indexes (here, 30-35) are written as display indexes onto the slice having an address of 5 in the display index control memory 109. The decoded image data is transferred from the decoder 102 to the B-picture memory 105 through the data bus 106 as described above. In the available index control memory 108, the read pointer RP is incremented by six. Therefore, the read pointer RP is moved from the address of 30 to an address of 35 and then back to the address of 0, which results in that the read pointer RP is set back to the same address as the write pointer WP.

When the read pointer RP and the write pointer WP become set at the same address, the processor 101 determines that the B-picture memory 105 is full, and stops the decoding.

While the decoding is stopped, the processor 101 transfers decoded image data of the top data of slice #0 from the B-picture memory 105 to the display 110 through the data bus 106. The display 110 uses the decoded image data received from the B-picture memory 105 to display it on screen.

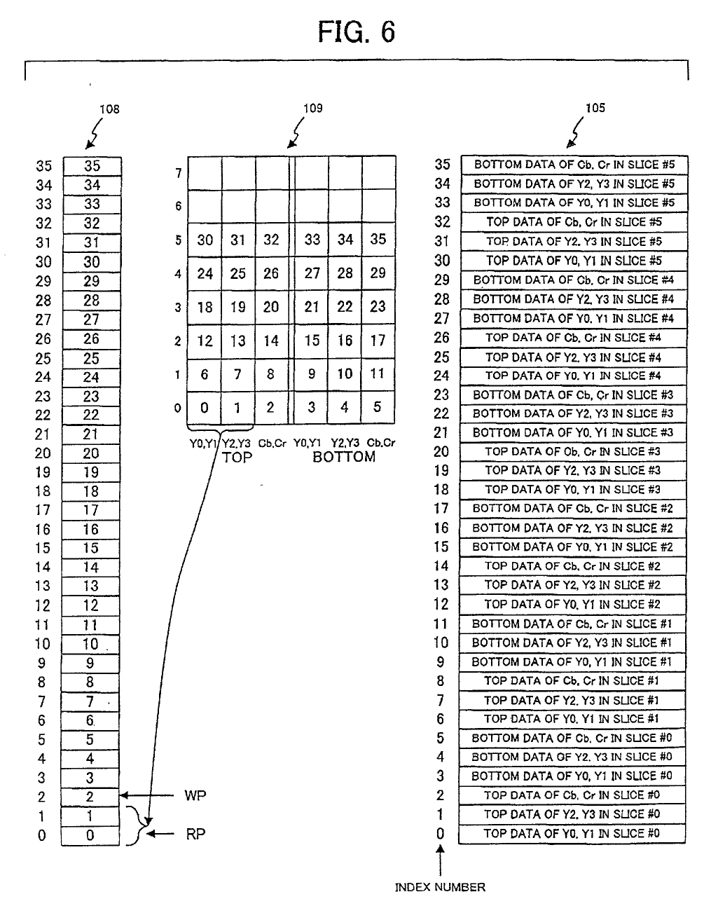

Referring to FIG. 6, when the displaying has been completed, the top data associated with the luminance signal Y of the slice #0 stored in the memory areas of indexes 0 and 1 are no longer necessitated. Therefore, the processor 101 releases the memory areas of the indexes 0 and 1. More specifically, as shown in FIG. 6, the release index data D_{RL} is written as new available indexes 0 and 1 onto memory areas having the addresses of 0 and 1 in the available index control memory 108. In this case, the write pointer WP is incremented by two to be set at an address of 2. This causes two available indexes to be ensured in the available index control memory 108. As described before, however, six indexes are required to decode one slice of the B picture. Therefore, the decoding remains stopped.

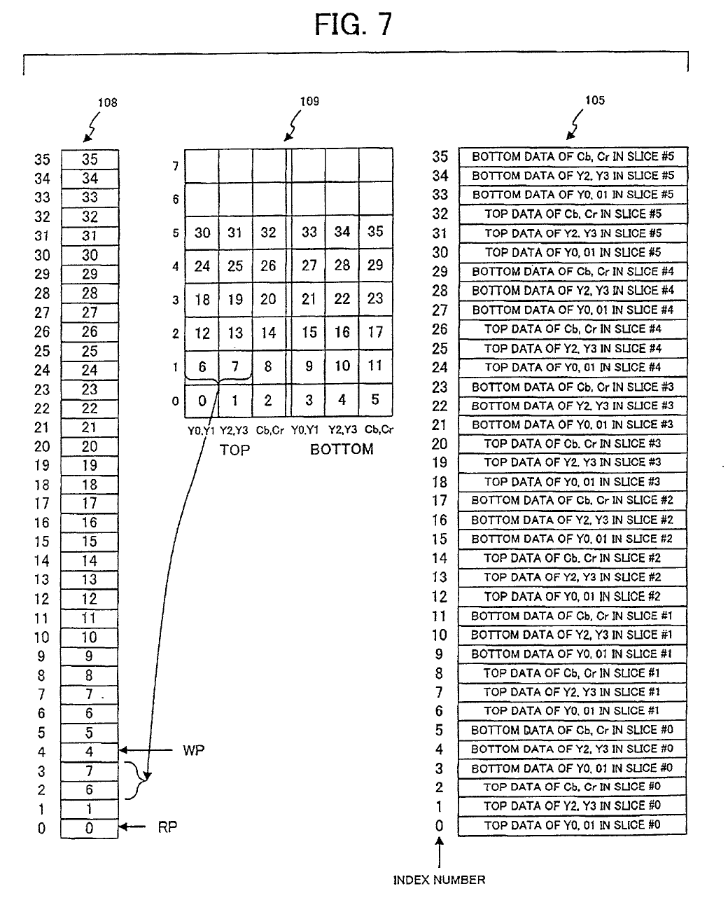

As shown in FIG. 7, when the displaying of the top data in the slice #1 has been completed, the top data associated with the luminance signal Y of the slice #1 stored in the memory areas of indexes 6 and 7 are no longer necessitated. Therefore, the processor 101 releases the memory areas of the indexes 6 and 7. More specifically, as shown in FIG. 7, the release index data D_{RL} is written as new available indexes 6 and 7 onto memory areas having the addresses of 2 and 3 in the available index control memory 108. In this case, the write pointer WP is incremented by two to be set at an address of 4. This causes a total of four available indexes to be ensured in the available index control memory 108. Since six indexes are required to decode one slice of the B picture, the decoding remains stopped.

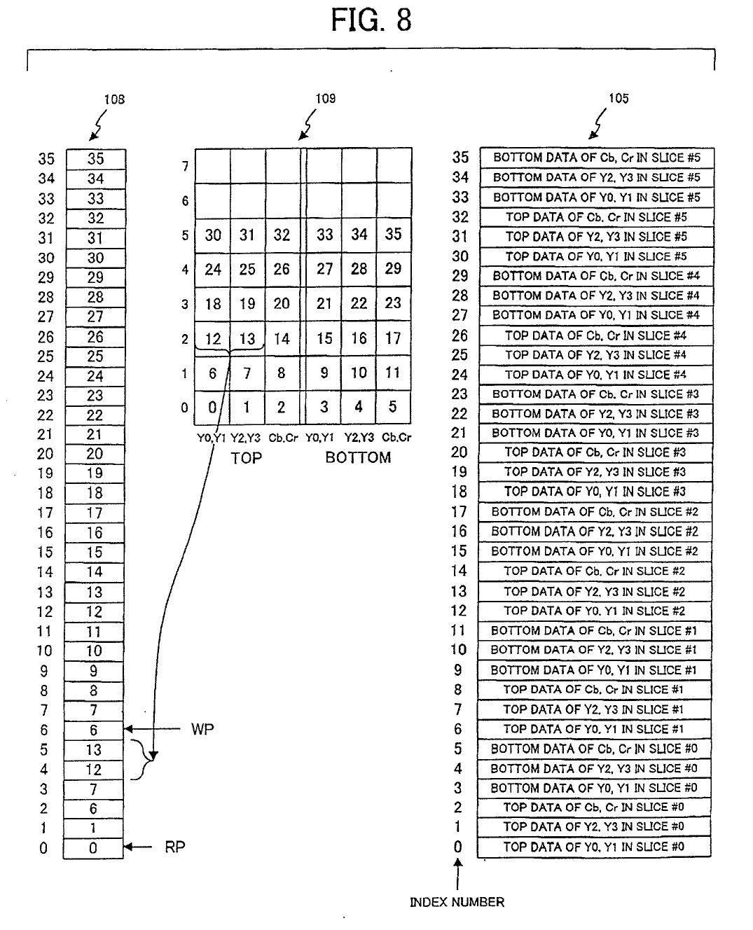

As shown in FIG. 8, when the displaying of the top data in the slice #2 has been completed, the top data associated with the luminance signal Y of the slice #2 stored in the memory areas of indexes 12 and 13 are no longer necessitated. Therefore, the processor 101 releases the memory areas of the indexes 12 and 13. More specifically, as shown in FIG. 8, the release index data D_{RL} is written as new available indexes 12 and 13 onto memory areas having the addresses of 4 and 5 in the available index control memory 108. In this case, the write pointer WP is incremented by two to be set at an address of 6. This causes a total of six available indexes to be ensured in the available index control memory 108. Since the number of available indexes reaches six, the decoding is restarted.

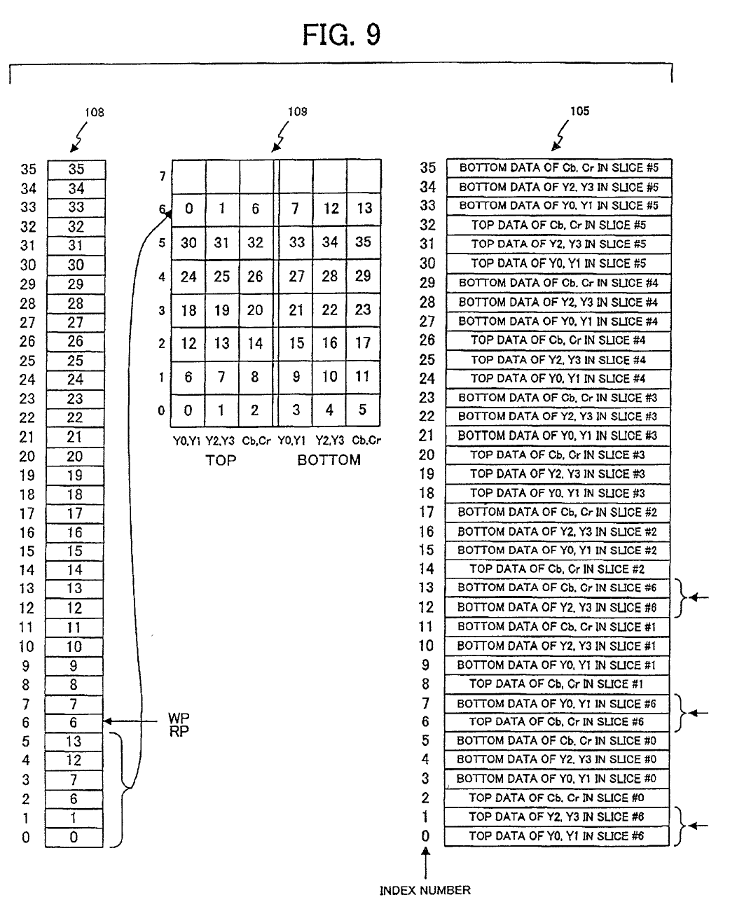

As shown in FIG. 9, the processor 101 reads available index data D_{AV} from the available index control memory 108 and the obtained six indexes (here, 0, 1, 6, 7, 12, and 13) are written as display indexes onto the slice having an address of 6 in the display index control memory 109. The decoded image data of the slice #6 is transferred from the decoder 102 to the B-picture memory 105 through the data bus 106 and is stored onto the memory areas indicated by indexes of 0, 1, 6, 7, 12, and 13.

In the B-picture memory 105, more specifically, the respective memory areas indicated by the indexes of 0 and 1 store the lower-half data (Y0, Y1) of a luminance signal Y in slice #6 of top and the lower-half data (Y2, Y3) of the luminance signal Y in slice #6 of top. The memory area indicated by the index of 6 stores data of the color-difference signal Cb, Cr in slice #6 of top. The memory area indicated by the index of 7 stores the lower-half data (Y0, Y1) of a luminance signal Y in slice #6 of bottom. The memory area indicated by the index of 12 stores the lower-half data (Y2, Y3) of a luminance signal Y in slice #6 of bottom. The memory area indicated by the index of 13 stores data of the color-difference signal Cb, Cr in slice #6 of bottom.

In the available index control memory 108, the read pointer RP is incremented by six. Therefore, the read pointer RP is moved from the address of 0 to an address of 6, which results in that the read pointer RP is set to the same address as the write pointer WP. As described before, when the read pointer RP and the write pointer WP become set at the same address, the processor 101 determines that the B-picture memory 105 is full, and stops the decoding.

Hereinafter, the control method according to a second embodiment of the present invention will be described in the case of decoding frame picture using a method other than the Progressive-c method. It is assumed that the case where a B picture consists of pixels of 128 (16×8) lines is taken and the B-picture memory 105, the available index control memory 108, and the display index control memory 109 are the same as in the case of the first embodiment.

As described in FIG. 5, when the read pointer RP and the write pointer WP become set at the same address, the processor 101 determines that the B-picture memory 105 is full, and stops the decoding. While the decoding is stopped, the processor 101 transfers decoded image data of the top data of slice #0 from the B-picture memory 105 to the display 110 through the data bus 106. The display 110 uses the decoded image data received from the B-picture memory 105 to display it on screen.

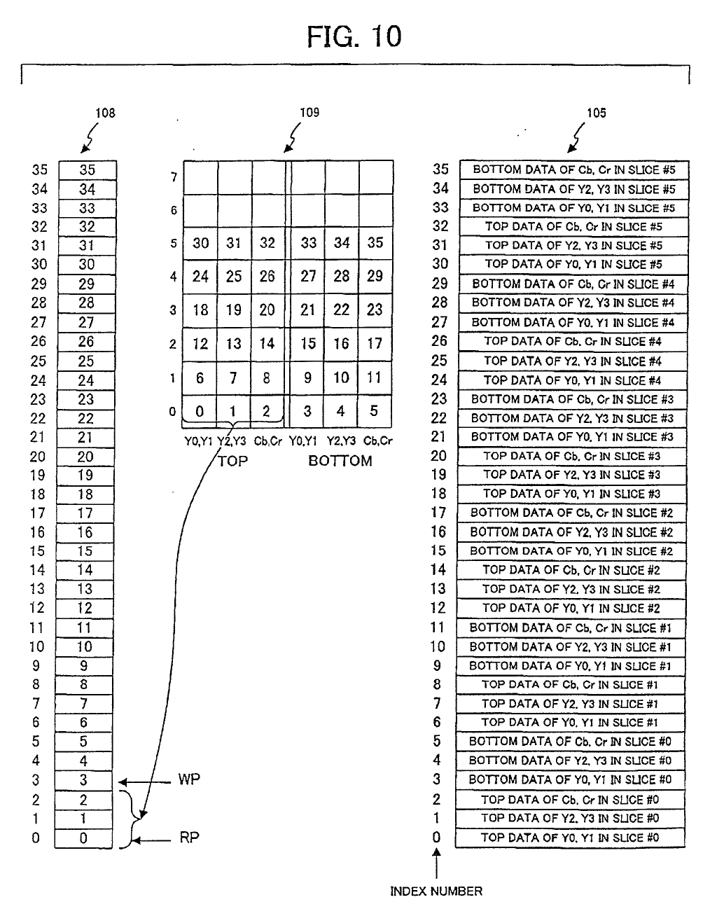

Referring to FIG. 10, when the displaying has been completed, the top data of the slice #0 stored in the memory areas of indexes 0-2 are no longer necessitated. Therefore, the processor 101 releases the memory areas of the indexes 0-2. More specifically, as shown in FIG. 10, the release index data D_{RL} is written as new available indexes 0-2 onto memory areas having the addresses of 0-2 in the available index control memory 108. In this case, the write pointer WP is incremented by three to be set at an address of 3. This causes three available indexes to be ensured in the available index control memory 108. As described before, however, six indexes are required to decode one slice of the B picture. Therefore, the decoding remains stopped.

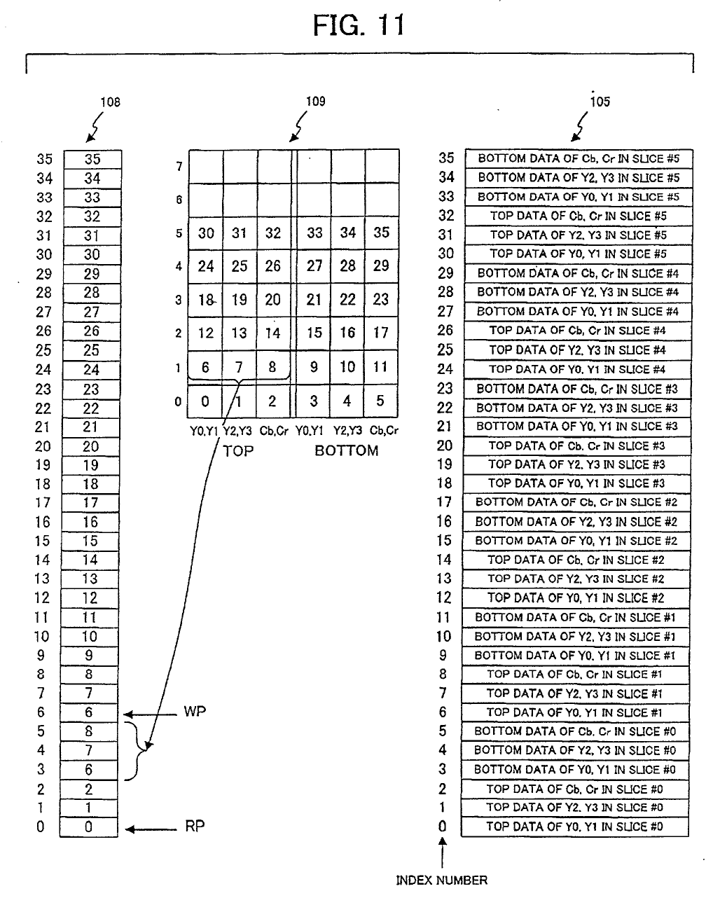

As shown in FIG. 11, when the displaying of the top data in the slice #1 has been completed, the top data of the slice #1 stored in the memory areas of indexes 6-8 7 are no longer necessitated. Therefore, the processor 101 releases the memory areas of the indexes 6-8. More specifically, as shown in FIG. 11, the release index data D_{RL} is written as new available indexes 6-8 onto memory areas having the addresses of 3-5 in the available index control memory 108. In this case, the write pointer WP is incremented by three to be set at an address of 6. This causes a total of six available indexes to be ensured in the available index control memory 108. Since the number of available indexes reaches six, the decoding is restarted.

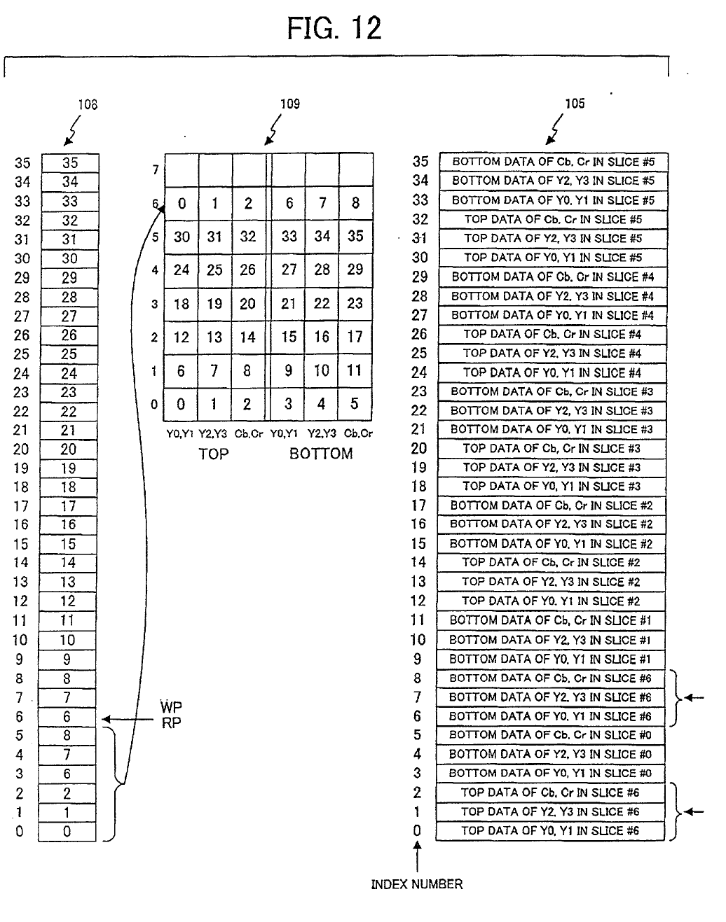

As shown in FIG. 12, the processor 101 reads available index data D_{AV} from the available index control memory 108 and the obtained six indexes (here, 0-2 and 6-8) are written as display indexes onto the slice having an address of 6 in the display index control memory 109. The decoded image data of the slice #6 is transferred from the decoder 102 to the B-picture memory 105 through the data bus 106 and is stored onto the memory areas indicated by indexes of 0-2 and 6-8.

In the B-picture memory 105, more specifically, the respective memory areas indicated by the indexes of 0-2 store the lower-half data (Y0, Y1) of a luminance signal Y in slice #6 of top, the lower-half data (Y2, Y3) of the luminance signal Y in slice #6 of top, and data of the color-difference signal Cb, Cr in slice #6 of top. The respective memory areas indicated by the indexes of 6-8 store the lower-half data (Y0, Y1) of a luminance signal Y in slice #6 of bottom, the lower-half data (Y2, Y3) of a luminance signal Y in slice #6 of bottom, and data of the color-difference signal Cb, Cr in slice #6 of bottom.

As described above, according to the present invention, a luminance signal and a color-difference signal are independently managed in each slice of B-picture data. Therefore, the memory areas corresponding to luminance signals can be released when a next line in the B picture is decoded, resulting in a reduction in capacity of a B-picture memory.

What is claimed is:

1. An image processor comprising:
a decoder for decoding moving-picture compression-encoded data including B picture data conforming to MPEG (Moving Picture Experts Group) standards;
a memory for storing luminance data and color-difference data of decoded image data included in a top field and a bottom field of a B picture;
a display for displaying pictures based on decoded image data; and
a memory controller for independently controlling a memory area storing the luminance data and another memory area storing the color-difference data in the memory.

2. The image processor according to claim 1, wherein the memory controller releases the memory area storing the luminance data included in one of the top and bottom fields that has been displayed.

3. The image processor according to claim 2, wherein, when a total of released memory areas has reached at least a predetermined amount, the memory controller writes decoded image data onto the released memory areas.

4. The image processor according to claim 1, wherein
the memory is divided into a plurality of memory areas each storing data of a predetermined number of lines in each slice of the B picture, wherein the memory areas are indexed, and
the memory controller comprises:
a first control memory for storing available index data indicating which memory area data of the predetermined number of lines can be stored onto;
a second control memory for storing display index data indicating which data of the predetermined number of lines is displayed; and
a controller for controlling the first and second control memories such that display index data indicating a memory area storing the luminance data included in a field that has been displayed is stored as available index data onto the first control memory to release the memory area storing the luminance data included in the field that has been displayed.

5. The image processor according to claim 4, wherein the controller releases not only the memory area storing the luminance data but also a memory area storing the color-difference data corresponding to the luminance data.

6. The image processor according to claim 4, wherein the second control memory stores display index data in such a manner that luminance data and color-difference data for each of the top and bottom fields are independently stored for each slice of the B picture.

7. In an image processor comprising:
a decoder for decoding moving-picture compression-encoded data including B picture data conforming to MPEG (Moving Picture Experts Group) standards; and
a display for displaying pictures based on decoded image data,
a method for displaying the pictures while decoding the moving-picture compression-encoded data, comprising the steps of:
a) storing luminance data and color-difference data of decoded image data included in a top field and a bottom field of a B picture onto a memory; and
b) independently controlling a memory area storing the luminance data and another memory area storing the color-difference data.

8. The method according to claim 7, wherein the step b) comprises the step of:
b-1) releasing the memory area storing the luminance data included in one of the top and bottom fields that has been displayed.

9. The method according to claim 8, wherein the step b) further comprises the step of:
b-2) when a total of released memory areas has reached at least a predetermined amount, writing decoded image data onto the released memory areas.

10. The method according to claim 7, wherein the memory is divided into a plurality of memory areas each storing data of a predetermined number of lines in each slice of the B picture, wherein the memory areas are indexed,
the step b) comprises the steps of:
b-1) storing available index data onto a first control memory, the available index data indicating which memory area data of the predetermined number of lines can be stored onto,
b-2) storing display index data onto a second control memory, the display index data indicating which data of the predetermined number of lines is displayed; and
b-3) storing display index data indicating a memory area storing the luminance data included in a field that has been displayed as available index data onto the first control memory to release the memory area storing the luminance data included in the field that has been displayed.

11. The method according to claim 10, wherein in the step b-3), not only the memory area storing the luminance data but also a memory area storing the color-difference data corresponding to the luminance data are released.

12. The method according to claim 10, wherein the second control memory stores display index data in such a manner that luminance data and color-difference data for each of the top and bottom fields are independently stored for each slice of the B picture.

13. An image processor comprising:
a decoder for decoding moving-picture compression-encoded data including B picture data conforming to MPEG (Moving Picture Experts Group) standards;
a memory for storing luminance data and color-difference data of decoded image data included in a top field and a bottom field of a B picture;
a display for displaying pictures based on decoded image data; and
a controller for releasing a memory area storing the luminance data included in a field that has been displayed before one of the top and bottom fields of the B picture is decoded.

14. The image processor according to claim 13, wherein the controller releases a memory area storing the luminance data included in a bottom field that has been displayed before the top field of the B picture is decoded.
